(19) United States
(12) Patent Application Publication
(10) Pub. No.: US 2023/0017567 A1
(43) Pub. Date: Jan. 19, 2023

(54) Housing Cover for a Battery Housing With Particle Protection and Heat Protection, Battery Housing, Traction Battery and Motor Vehicle

(71) Applicant: Bayerische Motoren Werke Aktiengesellschaft, Muenchen (DE)

(72) Inventors: Frank HEHNE, Muenchen (DE); Andreas OBERMAIER, Muenchen (DE)

(21) Appl. No.: 17/785,308

(22) PCT Filed: Dec. 15, 2020
(86) PCT No.: PCT/EP2020/086080

§ 371 Date: Jun. 14, 2022

(30) Foreign Application Priority Data
Jan. 17, 2020 (DE) 10 2020 101 039.7

(51) Int. Cl. H01M 50/375; H01M 50/159

(52) U.S. Cl. CPC H01M 50/375; H01M 50/159; H01M 2220/20

(57) ABSTRACT

A housing cover is provided for placement on a housing lower part of a battery housing of a traction battery of an electrically driveable motor vehicle. The housing cover includes a cover layer for closing off a housing interior of the battery housing accommodating at least one battery cell, and a protection layer overlapping at least in part with the cover layer to withstand a thermal load caused by a supply of heat to the housing cover in the event of an emergency gassing of the at least one battery cell. The protection layer is mechanically connected in connection regions to the cover layer and is arranged in protection regions at a distance from the cover layer, thus forming a gap intended to increase a thermal transfer resistance between the protection layer and the cover layer.

### BACKGROUND AND SUMMARY

The invention relates to a housing cover for a battery housing of a traction battery of an electrically drivable motor vehicle for placement on a housing lower part of the battery housing. The housing cover has a cover layer for closing off a housing interior, which receives at least one battery cell, of the battery housing. The invention also relates to a battery housing, to a traction battery and to an electrically drivable motor vehicle.

In the present case, interest is directed to traction batteries for electrically drivable motor vehicles, that is to say hybrid or electric vehicles. Such traction batteries usually have a plurality of interconnected battery modules which are arranged in a housing interior of a battery housing. Battery cells of the battery modules usually each have a degassing element in order to allow a hot gas, which arises during a thermal event, for example with a short circuit within itself, in a cell housing of the battery cell, to escape from the cell housing. This is also referred to as emergency degassing. A housing cover of the battery housing, which is usually arranged overlapping with the degassing elements of the battery cells, is directly exposed to this hot gas. Since heat is transported into the housing interior by this hot gas, the housing cover is exposed to high thermal loading. In order to prevent a failure of the housing cover and thus to ensure the protection of vehicle occupants of the motor vehicle, the housing cover is usually configured with a high material thickness. However, this results in a high weight, a high installation space requirement and high material costs of the traction battery.

It is the object of the present invention to configure a traction battery for an electrically drivable motor vehicle to be particularly secure and robust with respect to emergency degassing of battery cells of the traction battery and, at the same time, in a particularly cost- and weight-saving manner.

This object is achieved according to the invention by a housing cover, a battery housing, a traction battery and a motor vehicle having the features according to the respective independent patent claims. Advantageous embodiments of the invention form the subject matter of the dependent patent claims, the description and the figure.

A housing cover according to the invention for a battery housing of a traction battery of an electrically drivable motor vehicle serves for placement on a housing lower part of the battery housing. The housing cover has a cover layer for closing off, in particular for sealing, a housing interior of the battery housing. The housing interior is designed to receive at least one battery cell. In addition, the housing cover has a protective layer, which overlaps with the cover layer at least in certain regions, for withstanding thermal loading which is caused by heating applied to the housing cover in the event of emergency degassing of the at least one battery cell. The protective layer is mechanically connected to the cover layer in connection regions and, in protection regions, is arranged at a distance from the cover layer with the formation of a gap intended to increase a thermal transfer resistance between the protective layer and the cover layer.

The invention also relates to a battery housing for a traction battery of an electrically drivable motor vehicle having a housing lower part and a housing cover according to the invention. The cover layer has an upper side facing the surroundings of the battery housing and an underside which faces the housing interior and on which the protective layer is arranged. A traction battery according to the invention for an electrically drivable motor vehicle has a plurality of battery cells and a battery housing according to the invention, wherein the battery cells are arranged in the housing interior of the battery housing.

The rechargeable traction battery or the traction accumulator is in particular an energy store having a voltage level of at least 48 V, in particular at least 60 V, and serves for supplying an electric drive machine of the motor vehicle with electrical energy. The battery cells can be, for example, round cells, pouch cells, or prismatic cells. The battery cells are, for example, connected to form battery modules, wherein the traction battery can have a plurality of interconnected battery modules. The battery modules are arranged in the housing interior of the battery housing. Cell housings of the battery cells can each have a degassing element, for example a rupture membrane, which is designed to allow emergency degassing of a battery cell. During emergency degassing, a hot gas arising as a result of a thermal event of the battery cell in the cell housing will be discharged from the cell housing to reduce the internal pressure. Such a thermal event can be, for example, a short circuit within a cell or overheating of the battery cell. Here, the hot gas causes heat to be transported from the cell housing of the battery cell into the housing interior of the battery housing.

The battery housing has a plurality of housing walls. Here, the housing cover is to be understood in particular as meaning that housing wall which is arranged overlapping with the degassing elements of the battery cells and therefore lies in a flow path of the hot gas of the degassing battery cells. For example, housing walls in the form of a housing bottom and housing side walls can form a trough-like housing lower part which can be covered by the housing cover. The housing cover is thus exposed to the hot gas and is therefore locally subjected to heat during emergency degassing of at least one battery cell.

In order then to prevent a situation in which the housing cover exposed to the hot gas in the event of a fault mechanically fails as a result of the local introduction of heat and is thus destroyed, the housing cover can have a multilayered design at least in certain regions. The housing cover has the cover layer which can be placed on the housing lower part and completely covers, in particular also seals, the housing interior. The cover layer is thus present over a whole surface area of the housing cover, wherein the upper side of the housing cover that faces the surroundings and an outer side of the housing lower part that faces the surroundings form an outer surface of the battery housing that faces the surroundings. The cover layer is in particular a metal sheet of a first sheet metal type, for example aluminum. The cover layer ensures the tightness and the corrosion protection of the battery housing. However, the cover layer has a comparatively low melting point, with the result that it can fail when subjected to the hot gas.

In order to design the housing cover to be mechanically stable to thermal loading, the housing cover has the protective layer which ensures the thermal protection of the housing cover. This protective layer is arranged on the underside of the cover layer at least in certain regions. The protective layer is in particular also a metal sheet consisting of a material different from the cover layer, for example of another sheet metal type. The housing cover is thus formed as a composite cover made up of different sheet metal types. In particular, the protective layer has a higher melting point than the cover layer. For example, the protective layer is formed from steel. Here, the protective layer can extend over a whole surface area of the underside of the cover layer, with the result that the housing cover is of multilayer design at each point. The protective layer can also be arranged on the underside of the cover layer only in certain regions, with the result that the housing cover is of multilayer design only locally. For example, the protective layer can consist of a plurality of steel plates which are arranged at least at those points on the underside of the cover layer that overlap with the degassing elements of the battery cells. The position of the protective layer is thus given by the action of heat on the housing cover during degassing of a cell.

Here, the protective layer is fastened to the cover layer in the connection regions or fastening regions. For this purpose, the protective layer is arranged in the connection regions so as to bear against the cover layer and is mechanically connected to the latter. In the protection regions, the protective layer is arranged at a distance from the cover layer with the formation of the gap. Here, the protection regions and the gap are situated so as to be overlapping with respect to or above the degassing elements and are thus arranged in the flow path of the hot gas. The gap is a gas-filled interspace, for example an air gap, between the cover layer and protective layer and increases the thermal transfer resistance between the protective layer and the cover layer. The gap has a defined dimension such that, during degassing of a cell, the temperature of the cover layer remains below the melting point of the cover layer. The larger the gap, that is to say the larger the distance between the cover layer and the protective layer, the greater the thermal transfer resistance. This increased thermal transfer resistance of the gap can prevent the heat of the hot gas being fully transmitted form the protective layer to the cover layer and destroying the latter.

By virtue of such a composite cover, the functions of “tightness” and “heat protection” are separated and split between the two layers, with the result that each layer can be optimized in terms of cost and weight. For example, the cover layer can be designed to be particularly thin and have, for example, a layer thickness of at most 2 mm, since it ensures only the tightness but not the heat protection.

With particular preference, the protective layer is connected to the cover layer in the connection regions without the use of an additional material. Preferably, the protective layer is connected to the cover layer in the connection regions by means of clinching. Clinching is a method for connecting metal sheets without the use of an additional material. The mechanical connection between the cover layer and the protective layer is achieved by forming of the materials of the layers. Connection regions which are produced by means of clinching have a high resistance to thermal loading. Moreover, there is advantageously no need for any additional materials, for example adhesives, to be provided, with the result that a particularly cost-effective and lightweight housing cover can be provided.

The invention also includes an electrically drivable motor vehicle having a traction battery according to the invention. The motor vehicle is in particular in the form of a passenger car.

The embodiments presented with respect to the housing cover according to the invention and the advantages thereof correspondingly apply to the battery housing according to the invention, to the traction battery according to the invention and to the motor vehicle according to the invention.

Further features of the invention will become apparent from the claims, the figure and the description of the figure. The features and combinations of features stated above in the description and also the features and combinations of features stated below in the description of the figure and/or shown in the figure alone may be used not only in the respectively specified combination but also in other combinations or in isolation.

The invention will now be explained in more detail on the basis of a preferred exemplary embodiment and with reference to the drawing.

### BRIEF DESCRIPTION OF THE DRAWING

FIG. 1 is a schematic illustration of a detail of a traction battery according to an embodiment of the invention for an electrically drivable motor vehicle.

### DETAILED DESCRIPTION OF THE DRAWING

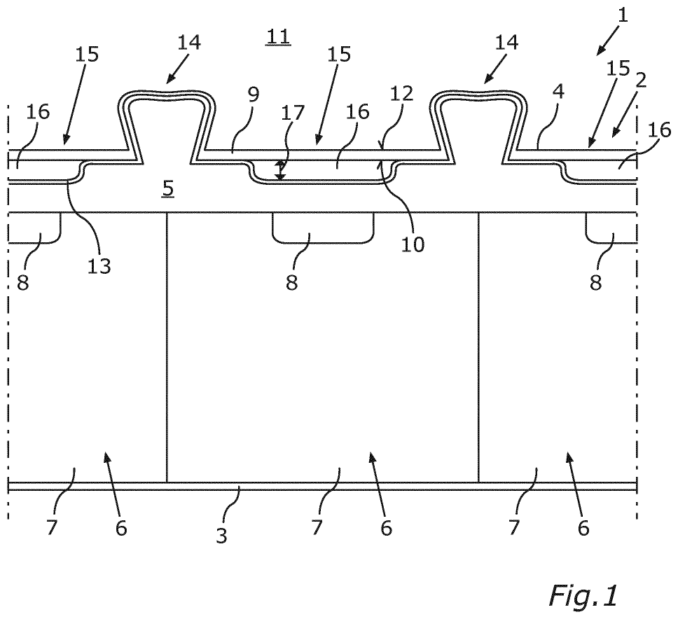

Referring to FIG. 1, the traction battery 1 has a battery housing 2 which comprises a housing lower part 3 and a housing cover 4. The housing lower part 3 and the housing cover 4 enclose a housing interior 5 in which a plurality of battery cells 6 can be arranged. The battery cells 6 can be designed, for example, as prismatic cells. The battery cells 6 each have, for example, a cell housing 7 with a degassing element 8. The degassing element 8 can be, for example, a rupture membrane. In the event of degassing of a cell or emergency degassing of a battery cell 6, it is possible by way of the degassing element 8 for a hot gas which forms in the cell housing 7 to escape from the cell housing 7 into the housing interior 5. This hot gas transports heat to the housing cover 4, which is arranged above the battery cells 6 and thus overlapping with the degassing elements 8.

In order now to prevent the housing cover 4 being destroyed by the hot gas, the housing cover 4 is of multilayer design at least in certain regions. The housing cover 4 has a cover layer 9 which has an underside 10 facing the housing interior 5 and an upper side 12 facing the surroundings 11. The cover layer 9 is formed in particular as an aluminum sheet which seals the housing interior 5 and protects it from corrosion. On the underside 10 of the cover layer 9 there is arranged a protective layer 13. Here, the protective layer 13 is arranged on the cover layer 9 at least above the degassing element 8 of the battery cells 6, with the result that only the protective layer 13, but not the cover layer 9, is directly exposed to the outflowing hot gas. The protective layer 13 is more heat-resistant to the heat transported by the hot gas than the cover layer 9 and has for this purpose in particular a higher melting point than the cover layer 9. The protective layer 13 can be, for example, a steel sheet.

Here, the protective layer 13 is mechanically connected to the cover layer 9 in connection regions 14, which are here illustrated as being greatly enlarged. Away from the connection regions 14 there are formed protection regions 15 in which the protective layer 13 is arranged at a distance from the cover layer 9 with the formation of an, in particular air-filled, gap 16. The protective layer 13 is thus connected to the cover layer 9 in certain regions and is arranged at a distance from the cover layer 9 in certain regions. Here, the connection regions 14 can be produced by clinching. In the connection regions 14, the housing cover 4 thus has a layer stack which is formed in particular only by the protective layer 13 and the cover layer 9. In the protection regions 15, the housing cover has a layer stack which is formed by the protective layer 13, the gap 16 and the cover layer 9.

By virtue of the gap 16, the thermal transfer resistance between the protective layer 13 and the cover layer 9 is increased. In particular, the thermal transfer resistance is set over a height 17 of the gap 16 in such a way that a thermally poorly conducting heat transfer path between the protective layer 13 and the cover layer 9 is formed via the gap 16. The heat of the hot gas thus acts on the cover layer 9 only to such an extent that a temperature of the cover layer 9 always remains below its melting point and the housing cover 4 thus mechanically withstands the thermal loading.

1.-9. (canceled)

10. A housing cover for placement on a housing lower part of a battery housing of a traction battery of an electrically drivable motor vehicle, comprising:
a cover layer of the battery housing, the cover layer being configured to close off a housing interior that receives at least one battery cell;
a protective layer overlapping with the cover layer at least in certain regions to withstand a thermal load caused by heat applied to the housing cover in an event of emergency degassing of the at least one battery cell, wherein
the protective layer is mechanically connected to the cover layer in connection regions and, in protective regions, is arranged at a distance from the cover layer so as to form a gap intended to increase a thermal transfer resistance between the protective layer and the cover layer.

11. The housing cover according to claim 10, wherein
the cover layer has a lower melting point than the protective layer.

12. The housing cover according to claim 10, wherein
the cover layer is made of aluminum.

13. The housing cover according to claim 10, wherein
the protective layer is made of steel.

14. The housing cover according to claim 10, wherein
the protective layer is connected to the cover layer in the connection regions without use of an additional material.

15. The housing cover according to claim 10, wherein
a clinched connection connects the protective layer to the cover layer in the connection regions.

16. A battery housing for a traction battery of an electrically drivable motor vehicle, comprising:
a housing lower part; and
a housing cover comprising:
a cover layer of the battery housing, the cover layer being configured to close off a housing interior that receives at least one battery cell;
a protective layer overlapping with the cover layer at least in certain regions to withstand a thermal load caused by heat applied to the housing cover in an event of emergency degassing of the at least one battery cell, wherein
the protective layer is mechanically connected to the cover layer in connection regions and, in protective regions, is arranged at a distance from the cover layer so as to form a gap intended to increase a thermal transfer resistance between the protective layer and the cover layer,
wherein the cover layer has an upper side facing surroundings of the battery housing and an underside facing the housing interior, and
wherein the protective layer is arranged on the underside of the cover layer.

17. A traction battery for an electrically drivable motor vehicle, comprising:
a plurality of battery cells; and
a battery housing, comprising:
a housing lower part; and
a housing cover comprising:
a cover layer of the battery housing, the cover layer being configured to close off a housing interior that receives the plurality of battery cells;
a protective layer overlapping with the cover layer at least in certain regions to withstand a thermal load caused by heat applied to the housing cover in an event of emergency degassing of at least one battery cell, wherein
the protective layer is mechanically connected to the cover layer in connection regions and, in protective regions, is arranged at a distance from the cover layer so as to form a gap intended to increase a thermal transfer resistance between the protective layer and the cover layer,
wherein the cover layer has an upper side facing surroundings of the battery housing and an underside facing the housing interior, and
wherein the protective layer is arranged on the underside of the cover layer.

18. An electrically drivable motor vehicle comprising a traction battery according to claim 17.
